(19) United States
(12) Patent Application Publication
(10) Pub. No.: US 2014/0069236 A1
(43) Pub. Date: Mar. 13, 2014

(54) COMPOSITE HAND TOOL EQUIPPED WITH STORAGE AND TRANSFORMATION FUNCTIONS

(71) Applicant: Yi-Feng LIU, New Taipei City (TW)

(72) Inventor: Yi-Feng LIU, New Taipei City (TW)

(21) Appl. No.: 13/609,709

(22) Filed: Sep. 11, 2012

(51) Int. Cl. B25B 13/46

(52) U.S. Cl. 81/60

(57) ABSTRACT

A composite hand tool comprises a storage handle and a ratchet head. The storage handle includes a connection end and a hinged end. The hinged end is pivotally coupled with a plurality of wrenches. The connection end has a mounting cavity and a plurality of latch grooves formed annularly on the mounting cavity. The ratchet head has a ratchet end formed in a shape mating the mounting cavity and a locking end. The locking end has a plurality of bumps corresponding to the latch grooves. The ratchet end has a strut with an indented coupling cavity formed on the top end thereof. Hence the locking end can be coupled in the mounting cavity to allow the coupling cavity on the ratchet end, and the ratchet end forms a storage state in which anyone of the wrenches can be turned downwards and extended in a usable condition.

### FIELD OF THE INVENTION

The present invention relates to a hand tool and particularly to a composite hand tool equipped with storage and transformation functions.

### BACKGROUND OF THE INVENTION

Hand tools are widely used in houses and plants. They often are made in a wide variety of types and forms, such as screwdrivers, ratchets, wrenches or the like. They might be not frequently used in the ordinary houses, but have to be prepared to meet unexpected requirements.

U.S. patent publication No. 20090314138 discloses a spanner which also provides storage function hinged with a plurality of wrenches of varying sizes. The wrenches can be removed when in use and saved when not in use to facilitate storage.

While the aforesaid spanner offers storage facility, it provides only wrench function. Users still have to prepare other types of hand tools such as screwdrivers, ratchets or the like to meet unexpected requirements.

In short, users mostly have to prepare and stock many types of commonly used tools that might be needed unexpectedly, such as screwdrivers, ratchets and wrenches. This causes a lot of problems in storage.

### SUMMARY OF THE INVENTION

The primary object of the present invention is to provide a composite hand tool that also provides storage and transformation functions to meet use and storage requirements.

To achieve the foregoing object the composite hand tool according to the invention comprises a storage handle (and a ratchet head. The storage handle includes a connection end and a hinged end. The hinged end is pivotally coupled with a plurality of wrenches. The connection end has a mounting cavity and a plurality of latch grooves formed annularly on the mounting cavity. The ratchet head has a ratchet end formed in a shape mating the mounting cavity and a locking end. The locking end has a plurality of bumps corresponding to the latch grooves. The ratchet end has a strut with an indented coupling cavity formed on the top end thereof.

By means of the structure set forth above, the locking end can be coupled in the mounting cavity, and the coupling cavity on the ratchet end can function as a ratchet socket. When the ratchet end is coupled in the mounting cavity, the hand tool is in a storage state, anyone of the wrenches can be turned downwards in an extended condition to be used as a spanner. Thus the composite hand tool can provide storage and transformation functions to better meet use requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention.

FIG. 3 is a sectional view of the invention.

FIG. 4 is a schematic view of the invention to store replaceable screw heads.

FIG. 5 is a perspective view of the invention transformed to a first style.

FIG. 6 is a perspective view of the invention transformed to a second style.

FIG. 7A is a schematic view of the invention used as a ratchet tool in a use condition.

FIG. 7B is a schematic view of the invention used as a ratchet tool in another use condition.

### DETAILED DESCRIPTION OF THE PREFERRED EMBODIMENTS

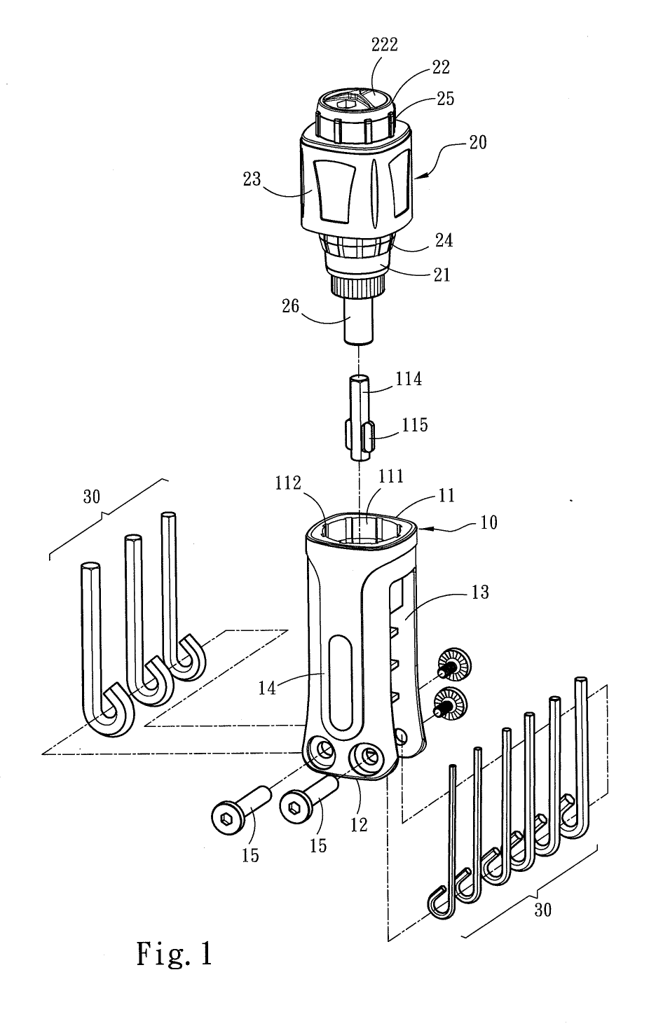

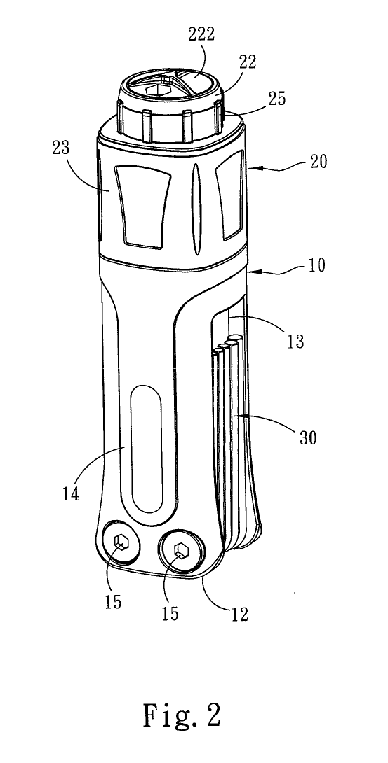

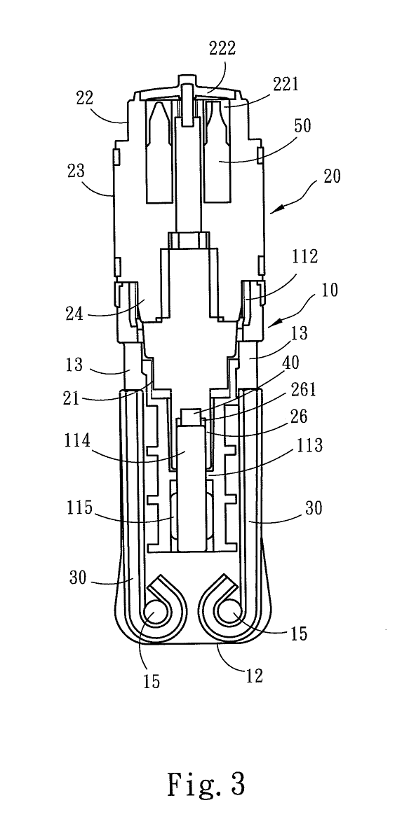

Please referring to FIGS. 1, 2 and 3, the present invention aims to provide a composite hand tool equipped with storage and transformation function. It comprises a storage handle 10 and a ratchet head 20. The storage handle 10 includes a connection end 11 and a hinged end 12. The hinged end 12 is pivotally coupled with a plurality of wrenches 30. The storage handle 10 has two storage troughs 13 at two opposite sides and an anti-slip trace 14. The wrenches 30 are held in anyone of the two storage troughs 13. Each storage trough 13 is run through by a pivot 15 with the wrenches 30 pivotally coupled on either one.

The connection end has a mounting cavity 111 and a plurality of latch grooves 112 formed annularly on the mounting cavity 111. The mounting cavity 111 has a latch rim 113 and a holding bar 114. The hold bar 114 has an anchor portion 115 run through the latch rim 113 and latched in the mounting cavity 111 to securely hold the holding bar 114.

The ratchet head 20 has a ratchet end 21 formed in a shape mating the mounting cavity 111 and a locking end 22. The ratchet head 20 also has a handgrip section 23 formed between the ratchet end 21 and locking end 22 to be gripped by a user's hand when in use. The ratchet end 21 and handgrip section 23 are interposed by a switch cap 24 which provides one-way transmission (turnable only in one direction) that is a common feature of the conventional hand tool. Through the switch cap 24 the turning direction of the ratchet head 20 can be switched as desired.

The locking end 22 has a plurality of bumps 25 corresponding to the latch grooves 112. The ratchet end 21 has a strut 26 with an indented coupling cavity 261 formed on the top end thereof. The coupling cavity 261 can hold a magnet 40. The holding bar 114 can be coupled in the coupling cavity 261.

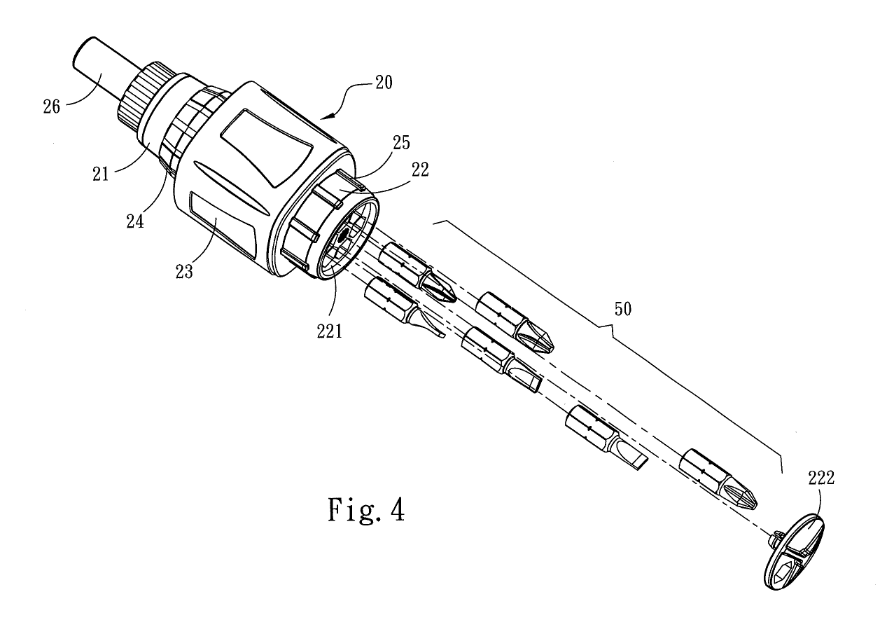

Also referring to FIG. 4, the locking end 22 has a holding chamber 221 indented outwards to hold at least replaceable screw head 50 which can be six sets in total with different profiles to meet different use requirements. The locking end 22 also is coupled with a lid 222 to cover the holding chamber 221.

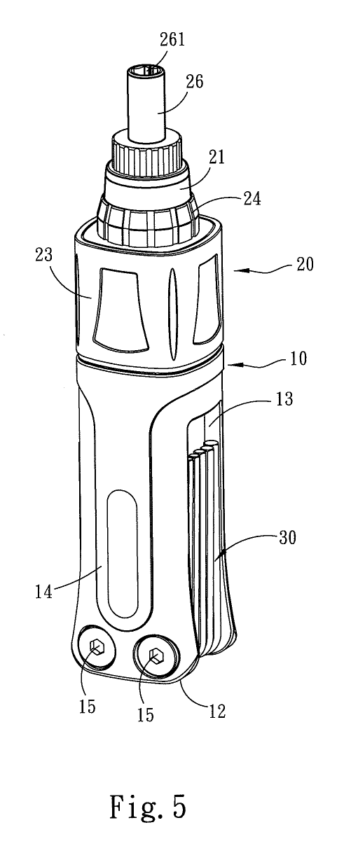

Please referring to FIG. 5, the locking end 22 can be coupled on the mounting cavity 111 with the bumps 25 latched on the latch grooves 112 so that the storage handle 10 can be turned in unison with the ratchet head 20. Because of the coupling cavity 261 on the ratchet end 21, it can function as a ratchet socket. Users can choose anyone of the replaceable screw heads 50 to be held in the coupling cavity 261 via attraction of the magnet 40, thereby to function as a transformable screwdriver.

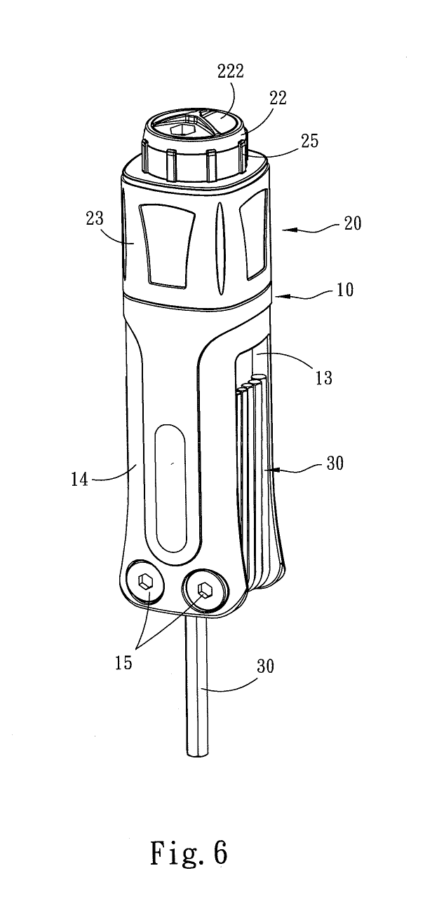

Also referring to FIG. 6, when the ratchet end 21 is coupled on the mounting cavity 111, it is in a storage state, anyone of the wrenches 30 can be moved downwards and extended to function as a transformable spanner and ratchet tool.

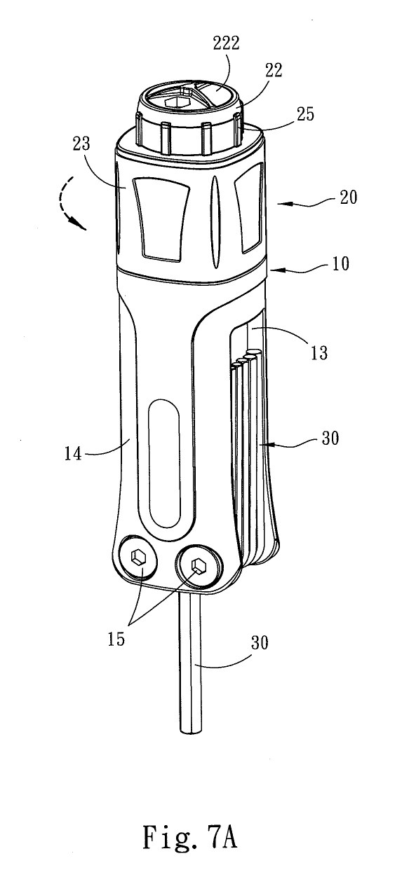

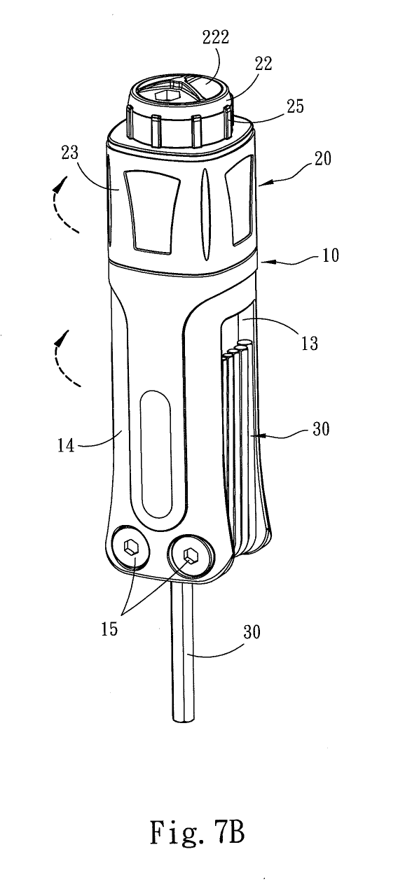

Please referring to FIGS. 7A and 7B, the storage handle 10 and ratchet end 20 are anchored by engagement of the coupling cavity 261 and holding bar 114. Through the one-way transmission of the switch cap 24 (i.e. turning in one direction) a one-way transmission can also be accomplished between the storage handle 10 and ratchet end 20. For instance, the ratchet head 20 can be turned counterclockwise independently (as shown in FIG. 7A); however, when turning clockwise is chosen, the ratchet head 20 and storage handle 10 are turned together (as shown in FIG. 7B) to function as a ratchet tool.

As a conclusion, the invention, through coupling of the locking end in the mounting cavity, can function as a ratchet tool. By attracting the replaceable screw heads into the mounting cavity via the magnet, it also can function as a screwdriver; and by coupling the ratchet end in the mounting cavity with the wrenches turned downwards and extended, it can provide wrench function. The composite hand tool thus formed is transformable to many types and also can provide storage function to better meet use requirements.

What is claimed is:

1. A composite hand tool equipped with storage and transformation functions, comprising:
a storage handle including a connection end and a hinged end which is pivotally coupled with a plurality of wrenches, the connection end including a mounting cavity and a plurality of latch grooves formed annularly on the mounting cavity; and
a ratchet head including a ratchet end formed in a shape mating the mounting cavity and a locking end, the locking end including a plurality of bumps corresponding to the latch grooves, the ratchet end including a strut which contains a coupling cavity indented inwards from a top end thereof.

2. The composite hand tool of claim 1, wherein the storage handle includes two storage troughs at two opposite sides thereof, the wrenches being held in anyone of the two storage troughs.

3. The composite hand tool of claim 2, wherein each storage trough is run through by a pivot, the wrenches being pivotally coupled on either pivot.

4. The composite hand tool of claim 1, wherein the mounting cavity includes a latch rim and a holding bar jointed with the coupling cavity, the holding bar including an anchor portion run through the latch rim and latched in the mounting cavity to securely hold the holding bar.

5. The composite hand tool of claim 1, wherein the locking end includes a holding chamber indented outwards to hold at least one replaceable screw head corresponding to and jointed with the coupling cavity.

6. The composite hand tool of claim 5, wherein the locking end includes a lid to cover the holding chamber.

7. The composite hand tool of claim 1, wherein the storage handle includes an anti-slip trace.

8. The composite hand tool of claim 1, wherein the ratchet head includes a handgrip section between the ratchet end and the locking end.

9. The composite hand tool of claim 8, wherein the ratchet end and the handgrip section are interposed by a switch cap.

10. The composite hand tool of claim 1, wherein the coupling cavity contains a magnet.
